(19) United States
(12) Patent Application Publication
(10) Pub. No.: US 2014/0332708 A1
(43) Pub. Date: Nov. 13, 2014

(54) ACETYLATED CELLULOSE ETHER, METHOD FOR PREPARING SAME, AND ARTICLE COMPRISING THE ACETYLATED CELLULOSE ETHER

(71) Applicants: Byoung Hee Son, Ulsan (KR); Tae Hong Kim, Yangsan-si (KR); Il Yong Lee, Daejeon (KR)

(72) Inventors: Byoung Hee Son, Ulsan (KR); Tae Hong Kim, Yangsan-si (KR); Il Yong Lee, Daejeon (KR)

(73) Assignee: SAMSUNG FINE CHEMICALS CO., LTD., Ulsan (KR)

(21) Appl. No.: 14/361,501

(22) PCT Filed: Nov. 16, 2012
(86) PCT No.: PCT/KR2012/009734

§ 371 Date: May 29, 2014

(30) Foreign Application Priority Data
Dec. 20, 2011 (KR) 10-2011-0138495

(51) Int. Cl. C08B 13/00

(52) U.S. Cl. CPC C08B 13/00
USPC 252/1; 536/66

(57) ABSTRACT

Disclosed are acetylated cellulose ether, a method of preparing the same, and an article including the same. The disclosed acetylated cellulose ether has a degree of substitution (DS) of alkyl group of 1 to 2, a molar substitution (MS) of hydroxyalkyl group of 0 to 1, and a degree of substitution (DS) of acetyl group of 1 to 2; and a bulk density of 0.1 to 0.4.

### TECHNICAL FIELD

The present invention relates to acetylated cellulose ether, a method of preparing the same, and an article including the same, and more particularly, to acetylated cellulose ether having a bulk density of 0.1 to 0.4, a method of preparing the same, and an article including the same.

### BACKGROUND ART

Cellulose has three hydroxyl groups (—OH) per anhydroglucose unit. As these hydroxyl groups form regular hydrogen bonds within a molecule, a rigid crystalline structure is formed. Accordingly, cellulose has a stable structure that is not soluble in water or organic solvents.

When some of the hydrogen bonds in cellulose are substituted with an alkyl group, the substituted cellulose has a less rigid crystalline structure compared to unsubstituted cellulose, and thus, the substituted cellulose is converted into a cellulose ether that is a water-soluble polymer.

In order to improve the solubility of the cellulose ether that is a water-soluble polymer into an organic solvent and to make use of the cellulose ether as thickeners, binders, or materials for membranes such as membranes for water-treatment, which are soluble in organic solvents, Korea Patent Publication No. 2011-0089662 discloses acetylated cellulose ether prepared by introducing an acetyl group into cellulose ether. However, the acetylated cellulose ether prepared in the above manner has a low bulk density so that the commercial use thereof is limited. That is, in order to expand the commercial use, a product (i.e., acetylated cellulose ether) with increased bulk density must be developed in order to address issues including dusting prevention, package property improvement, flowability improvement in a storage container (for example, a silo), and fluidity improvement of the product in an extruder feeder.

### DETAILED DESCRIPTION OF THE INVENTION

### Technical Problem

An embodiment of the present invention provides acetylated cellulose ether having a bulk density of 0.1 to 0.4.

Another embodiment of the present invention provides a method of preparing the acetylated cellulose ether.

Another embodiment of the present invention provides an article including the acetylated cellulose ether.

### Technical Solution

According to an aspect of the present invention, there is provided acetylated cellulose ether including: a degree of substitution (DS) of alkyl group of 1 to 2, a degree of molar substitution (MS) of hydroxyalkyl group of 0 to 1, and a degree of substitution (DS) of acetyl group of 1 to 2; and having a bulk density of 0.1 to 0.4.

The acetylated cellulose ether may be prepared by acetylating at least one cellulose ether selected from the group consisting of methylcellulose, hydroxypropylmethylcellulose, and hydroxyethylmethylcellulose.

According to another aspect of the present invention, there is provided an article including the acetylated cellulose ether.

The article may be a packaging material, a fiber, a case of home appliance, a metal paste, or a separation membrane material.

According to another aspect of the present invention, there is provided a method of preparing acetylated cellulose ether, the method comprising: dissolving acetylated cellulose ether, which has a degree of substitution (DS) of alkyl group of 1 to 2, a degree of molar substitution (MS) of hydroxyalkyl group of 0 to 1, and a degree of substitution (DS) of acetyl group of 1 to 2, in an organic solvent to obtain a solution of the acetylated cellulose ether; and adding water to the solution of the acetylated cellulose ether to precipitate the acetylated cellulose ether.

The organic solvent may include at least one compound selected from the group consisting of methanol, acetic acid, acetone, dimethylformamide, dimethyl sulfoxide, and 1-methoxy-2-propanol.

The method of preparing the acetylated cellulose ether may further include washing and drying the precipitated acetylated cellulose ether.

### Advantageous Effects

The acetylated cellulose ether according to an embodiment of the present invention may be soluble in an organic solvent, and accordingly may be applied for films for packing, fiber products and materials for high-strength membranes such as membranes for water-treatment, which may be manufactured using the organic solvent. In addition, the acetylated cellulose ether has a high bulk density, and thus, may have improved flowability, and accordingly, improvement of flowability in an extruder feeder, dusting prevention effects, and improvement of flowability within a silo may be obtained, thereby being possible to be applied for various commercial uses.

### Best Mode

Hereinafter, acetylated cellulose ether, a preparation method thereof, and an article including the acetylated cellulose ether, according to embodiments of the present invention, will be described in more detail.

The acetylated cellulose ether according to an embodiment of the present invention has a degree of substitution (DS) of alkyl group of 1 to 2, a degree of molar substitution (MS) of hydroxyalkyl group of 0 to 1, and a degree of substitution (DS) of acetyl group of 1 to 2; and a bulk density of 0.1 to 0.4. The term “bulk density” used in the specification refers to a value obtained by dividing the mass of a material by the volume of the material.

The acetylated cellulose ether may be prepared by acetylating cellulose ether having the DS of alkyl group of 1 to 2 and the MS of hydroxyalkyl group of 0 to 1. In this regard, the alkyl group may have 1 to 16 carbon atoms. In the preparation of the acetylated cellulose ether, cellulose or cellulose ether having the DS and MS within the ranges described above may be used as a starting material.

By the acetylation of the cellulose ether having the DS of alkyl group and the MS of hydroxyalkyl group within the ranges described above, acetylated cellulose ether that is not dissolved in water but is dissolved in an organic solvent such as acetone and that has high molecular weight ensuring excellent mechanical strength may be obtained. A detailed description thereof will be described later.

The acetylated cellulose ether may have a DS of acetyl group of 1 to 2.

In addition, the acetylated cellulose ether may have a bulk density of 0.1 to 0.4 (for example, 0.1 to 0.3). When the acetylated cellulose ether has a bulk density within the ranges described above, flowability thereof may be improved, and accordingly improvement of flowability in an extruder feeder, and dusting prevention effects, and improvement of flowability within a silo may be obtained, so that the acetylated cellulose ether may be applied for various commercial uses.

The acetylated cellulose ether may be prepared by acetylating at least one cellulose ether selected from the group consisting of methylcellulose, hydroxypropylmethylcellulose, and hydroxyethylmethylcellulose.

In addition, a viscosity of a solution prepared by dissolving the acetylated cellulose ether in acetone (to a concentration of the acetylated cellulose ether of 2 wt %) may be in a range of 5 to 100,000 centipoise (cps) when measured by a Brookfield viscometer at 20° C. and at 20 rpm. When the viscosity of the solution is within the ranges described above, the acetylated cellulose ether has excellent mechanical strength.

The acetylated cellulose ether may have a melting point in a range of 180 to 250° C. When the melting point of the acetylated cellulose ether is within the ranges described above, the acetylated cellulose ether may be applied to a melt processing such as injection molding.

Hereinafter, a method of preparing the acetylated cellulose ether according to an embodiment of the present invention will be described in detail.

First, cellulose ether is prepared by etherifying a hydroxyl group of cellulose. That is, by the etherification of the cellulose, some of the hydroxyl groups within the cellulose structure are blocked or a hydrogen atom of the hydroxyl group is substituted with other substituents (for example, R₁ to R₅ described later) so as to prepare cellulose ether. Although the backbone of cellulose is maintained without being cut, hydrogen bonds therein are destructed, and accordingly the cellulose is changed to have an amorphous structure, thereby obtaining water-soluble cellulose ether with high molecular weight. Then, a hydrogen atom of hydroxyl group in the prepared water-soluble cellulose ether is substituted with an acetyl group (CH₃CO⁻) (acetylation) to prepare acetylated cellulose ether that is insoluble in water. Formulae 1 and 2 below show processes of converting anhydroglucose, as a basic repeating unit of cellulose, into a basic repeating unit of acetylated cellulose ether by etherification and acetylation of the anhydroglucose in the stated order.

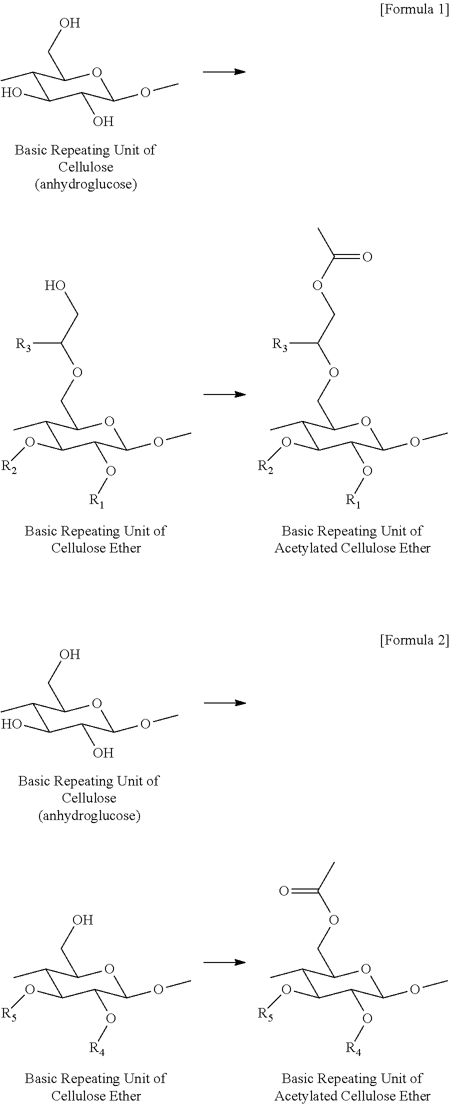

Formula 1 above shows that the cellulose is converted into hydroxyalkylalkylcellulose by etherification, and then, the hydroxyalkylalkylcellulose is converted into acetylated cellulose ether by acetylation. Formula 2 above shows that the cellulose is converted into alkylcellulose by etherification, and then, the alkylcellulose is converted into acetylated cellulose ether by acetylation.

In Formula 1 above, R₁ and R₂ may be each independently H, CH₃, CH₂CH₂OH, or CH₂CH(CH₃)OH, and R₃ may be H or CH₃.

In Formula 2 above, R₄ and R₅ may be each independently H or CH₃, and at least one of R₄ and R₅ is CH₃.

The term “degree of substitution (DS)” of alkyl group or acetyl group used in the specification refers to the average number of hydroxyl groups substituted with alkyl group(s) or acetyl group(s) per anhydroglucose unit. Since one anhydroglucose unit includes three hydroxyl groups at the most, a theoretical maximum DS of alkyl group or acetyl group is 3 when substituted with a mono-functional substituent. However, a multi-functional or polymerizable substituent may react with a hydroxyl group contained in the anhydroglucose unit, and also may react with itself, so that a DS thereof is not limited to 3. In addition, the term “degree of molar substitution (MS)” of hydroxyalkyl group used herein refers to the number of moles of multi-functional or polymerizable substituent(s) per anhydroglucose unit. There is no theoretical maximum value of the MS of hydroxyalkyl group.

The acetylated cellulose ether according to an embodiment of the present invention may be prepared by substituting hydrogen atoms of most of the hydroxyl groups that are contained in cellulose ether with hydrophobic acetyl groups. Thus, the acetylated cellulose ether is not soluble in water, but is soluble in an organic solvent.

The prepared acetylated cellulose ether is a filamentous shape, and has a bulk density of less than 0.1.

Then, the acetylated cellulose ether being in a filamentous in shape and having a bulk density of less than 0.1 is dissolved in an organic solvent so as to obtain a solution of the acetylated cellulose ether.

The organic solvent may include at least one compound selected from the group consisting of methanol, acetic acid, acetone, dimethylformamide (DMF), dimethyl sulfoxide (DMSO), and 1-methoxy-2-propanol (MP).

Then, water is added (for example, added dropwise) to the solution of the acetylated cellulose ether so as to precipitate the acetylated cellulose ether. The addition of water may be carried out until the precipitation of the acetylated cellulose ether continues. That is, the addition of water may be carried out until the organic solvent having a concentration of 100 wt % is diluted to a concentration of 80 wt % or less, 70 wt % or less, 50 wt % or less, 40 wt % or less, 30 wt % or less, 20 wt % or less, and 10 wt % or less. The precipitated acetylated cellulose ether is round particle shaped and has a bulk density of 0.1 to 0.4.

Finally, the precipitated acetylated cellulose ether is subjected to washing and drying. The washing may be carried out by using, for example, excess of water as a cleaning solution, and the drying may be carried out at a temperature of 60 to 100° C. for 30 minutes to 10 hours.

Meanwhile, an article according to an embodiment of the present invention includes the acetylated cellulose ether. The article may be, for example, a packaging material, a fiber, a case of home appliance, a metal paste, or a material for separation membrane (e.g., a membrane for water-treatment, a gas separation membrane, or a separator for battery).

### Mode of the Invention

Hereinafter, one or more embodiments will be described in detail with reference to the following examples. However, these examples are not intended to limit the purpose and scope of the invention.

### EXAMPLES

### Preparation Examples 1 to 7

### Preparation of Acetylated Cellulose Ether

70 g of a cellulose ether product (manufactured by Samsung Fine Chemicals, Co., Ltd.), 1,120 g of acetic anhydride, and 350 g of pyridine were added to a 3 L reactor to equipped with a stirrer, and the reactor content was maintained at 90° C. for 3 hours while stirring at 200 rpm to prepare acetylated cellulose ether. Then, the resulting reactor content was sprayed into a 18 L coagulating bath filled with water for coagulation, and washed out the resulting coagulum with clean water 5 times, followed by drying, thereby obtaining filamentous acetylated cellulose ether. The DS of methyl group, the MS of hydroxypropyl, and the MS of hydroxyethyl group of each of the cellulose ether products that were used in Examples 1 to 9, and the molar ratios of the acetic anhydrides that were used per anhydroglucose unit contained in each of the cellulose ether products are shown in Table 1 below.

TABLE 1

| | Cellulose Ether Product | | | Acetic |
|---|---|---|---|---|
| | DS of | MS of | MS of | anhydride/ |
| | methyl | hydroxypropyl | hydroxyethyl | anhydroglucose |
| | group | group | group | unit (molar ratio) |
| Preparation | 1.80 | 0.21 | — | 16.74 |
| Example 1 | | | | |
| Preparation | 1.58 | 0.22 | — | 16.53 |
| Example 2 | | | | |
| Preparation | 1.35 | 0.75 | — | 18.84 |
| Example 3 | | | | |
| Preparation | 1.91 | — | — | 15.85 |
| Example 4 | | | | |
| Preparation | 1.40 | — | 0.25 | 16.17 |
| Example 5 | | | | |
| Preparation | 1.65 | — | 0.23 | 16.39 |
| Example 6 | | | | |
| Preparation | 1.81 | — | 0.28 | 16.76 |
| Example 7 | | | | |

### Examples 1 to 7

### Post-treatment of Acetylated Cellulose Ether

Each of the acetylated cellulose ethers of Preparation Examples 1 to 7 was dissolved in an organic solvent having a concentration of 100 wt % shown in Table 2 below to prepare a solution of the acetylated cellulose ether, and then water was added thereto to precipitate the acetylated cellulose ether. Then, the precipitated acetylated cellulose ether was washed out with excess water, followed by drying at 80° C. for 6 hours, thereby obtaining round particle-shaped acetylated cellulose ether. In this case, as the amount of water to be added was increased, the concentration of the organic solvent was decreased. Here, (i) a concentration of the organic solvent at which the precipitation started and a bulk density (B/D) of the acetylated cellulose ether precipitated at this point, and thereafter, (ii) a concentration of the organic solvent at which a bulk density thereof reached the maximum valve and a bulk density (B/D) of the acetylated cellulose ether precipitated at this point, were each measured and are shown in Table 2 below. The bulk density (B/D) of each of the precipitated acetylated cellulose ethers was measured by using a GASA densimeter (HJ-6010 manufactured by Heungjin Testing Machine).

TABLE 2

| The used organic | | | | | | | | |
|---|---|---|---|---|---|---|---|---|
| solvent and | | | | | | | | |
| concentration of the | | | | | | | | |
| organic solvent at | | Bulk density (ml/g) | | | | | | |
| which the precipitation | | Example | Example | Example | Example | Example | Example | Example |
| started | | 1 | 2 | 3 | 4 | 5 | 6 | 7 |
| Methanol | 60 wt % | — | 0.19 | — | 0.17 | 0.18 | — | 0.24 |
| | 30 wt % | — | 0.20 | — | 0.19 | 0.19 | — | 0.26 |
| Acetic acid | 40 wt % | 0.31 | — | 0.23 | 0.18 | — | 0.27 | — |
| | 20 wt % | 0.29 | — | 0.25 | 0.19 | — | 0.25 | — |
| Acetone | 76 wt % | — | 0.25 | — | 0.17 | — | 0.22 | — |
| | 40 wt % | — | 0.27 | — | 0.19 | — | 0.23 | — |
| DMF | 80 wt % | 0.28 | — | 0.20 | — | 0.18 | — | 0.24 |
| | 40 wt % | 0.25 | — | 0.21 | — | 0.19 | — | 0.25 |
| DMSO | 85 wt % | — | 0.21 | — | 0.14 | 0.20 | — | 0.23 |
| | 30 wt % | — | 0.20 | — | 0.16 | 0.21 | — | 0.21 |
| MP | 50 wt % | — | 0.19 | — | 0.16 | — | 0.15 | — |
| | 10 wt % | — | 0.20 | — | 0.17 | — | 0.17 | — |

Referring to Table 2 above, the acetylated cellulose ether of Examples 1 to 7 had a bulk density of 0.14 to 0.31. In addition, a starting point of the precipitation of the acetylated cellulose ether was different depending on types of the used organic solvent. That is, when 100 wt % methanol was used, the precipitation started when methanol was diluted to 60 wt %, and was completed when methanol was diluted to 30 wt %; when 100 wt % acetic acid was used, the precipitation started when acetic acid was diluted to 40 wt %, and was completed when acetic acid was diluted to 20 wt %; in the case of using 100 wt % acetone, the precipitation has been started when acetone was diluted to 76 wt %, and has been completed when acetone was diluted to 40 wt %; when 100 wt % DMF was used, the precipitation started when DMF was diluted to 80 wt %, and was completed when DMF was diluted to 40 wt %; when 100 wt % DMSO was used, the precipitation started when DMSO was diluted to 85 wt %, and was completed when DMSO was diluted to 30 wt %; and when 100 wt % MP was used, the precipitation started when MP was diluted to 50 wt %, and was completed when MP was diluted to 10 wt %.

### Comparative Examples 1 to 7

### Acetylated Cellulose Ether Without Post-Treatment

Regarding each of the acetylated cellulose ethers of Preparation Examples 1 to 7 not subjected to post-treatment, a bulk density (B/D), a DS of acetyl group, and viscosity thereof were measured and are shown in Table 3 below.

TABLE 3

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Bulk density | 0.05 | 0.03 | 0.07 | 0.04 | 0.03 | 0.03 | 0.08 |
| (ml/g) | | | | | | | |
| DS of acetyl | 1.16 | 1.35 | 1.56 | 1.03 | 1.53 | 1.48 | 1.14 |
| group* | | | | | | | |
| Viscosity**(cps) | 400 | 65,000 | 35,000 | 3,000 | 40,000 | 25,000 | 48,000 |

*Measuring method of DS of acetyl group: Free acetic acid that is generated by saponification of each of the acetylated cellulose ethers was titrated with an alkaline material to measure the DS of acetyl group of each of the acetylated cellulose ethers (ASTM D871-96).
**Viscosity measurement: The viscosity of each solution (i.e., a 2 wt % acetylated cellulose ether solution) that was prepared by dissolving each of the acetylated cellulose ethers in acetone was measured by using a Brookfield viscometer at 20° C. and at 20 rpm.

Referring to Table 3 above, the acetylated cellulose ethers of Comparative Examples 1 to 7 (that is, Preparation Examples 1 to 7) had a bulk density of 0.03 to 0.08, DS of acetyl group of 1.03 to 1.56, and viscosity of 400 to 65,000 cps.

Meanwhile, the bulk densities of the acetylated cellulose ethers of Examples 1 to 7 were different from those of the acetylated cellulose ethers of Comparative Examples 1 to 7, but the DSs of acetyl group and the viscosities of the acetylated cellulose ethers of Examples 1 to 7 were equal to those of the acetylated cellulose ethers of Comparative Examples 1 to 7.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. Acetylated cellulose ether comprising:
a degree of substitution (DS) of alkyl group of 1 to 2, a degree of molar substitution (MS) of hydroxyalkyl group of 0 to 1, and a degree of substitution (DS) of acetyl group of 1 to 2; and
a bulk density of 0.1 to 0.4.

2. The acetylated cellulose ether of claim 1, wherein the acetylated cellulose ether is prepared by acetylating at least one cellulose ether selected from the group consisting of methylcellulose, hydroxypropylmethylcellulose, and hydroxyethylmethylcellulose

3. An article comprising the acetylated cellulose ether according to claim 1.

4. The article of claim 3, wherein the article is a packaging material, a fiber, a case of home appliance, a metal paste, or a material for separation membrane.

5. A method of preparing acetylated cellulose ether, the method comprising:
dissolving acetylated cellulose ether which has a degree of substitution (DS) of alkyl group of 1 to 2, a molar substitution (MS) of hydroxyalkyl group of 0 to 1, and a degree of substitution (DS) of acetyl group of 1 to 2 in an organic solvent to obtain a solution of the acetylated cellulose ether; and
adding water to the solution of the acetylated cellulose ether to precipitate the acetylated cellulose ether.

6. The method of claim 5, wherein the organic solvent comprises at least one compound selected from the group consisting of methanol, acetic acid, acetone, dimethylformamide, dimethyl sulfoxide, and 1-methoxy-2-propanol.

7. The method of claim 5, further comprising washing and drying the precipitated acetylated cellulose ether.

8. An article comprising the acetylated cellulose ether according to claim 2.
